(19) United States
(12) Patent Application Publication
(10) Pub. No.: US 2019/0016300 A1
(43) Pub. Date: Jan. 17, 2019

(54) STEERING COLUMN WITH AN ELECTRICAL STEERING LOCK

(71) Applicants: THYSSENKRUPP PRESTA AG, Eschen (LI); thyssenkrupp AG, Essen (DE)

(72) Inventors: Ulrich SCHLEGEL, Fläsch (CH); Deniz ILHAN, Rüthi (CH)

(73) Assignees: THYSSENKRUPP PRESTA AG, Eschen (LI); thyssenkrupp AG, Essen (DE)

(21) Appl. No.: 16/070,175

(22) PCT Filed: Jan. 17, 2017
(86) PCT No.: PCT/EP2017/050856

§ 371 Date: Jul. 13, 2018

(30) Foreign Application Priority Data
Jan. 25, 2016 (DE) 10 2016 000 635.8

(51) Int. Cl. B60R 25/0215; B60R 25/021; B62D 15/02; B60R 16/027

(52) U.S. Cl. CPC B60R 25/02153; B60R 16/027; B62D 15/0215; B60R 25/02105

(57) ABSTRACT

A steering column for a motor vehicle may include a steering shaft that is rotatably mounted in a boxed swing arm, a latching element connected to the steering shaft in a torsion-resistant manner, a locking element that may be brought into engagement with the latching element for temporary blocking of the steering shaft, a sensor arrangement that detects a steering parameter such as an angle of rotation of the steering shaft or a torque acting on the steering shaft, and an electromechanical actuator for actuating the locking element depending on a control. The sensor arrangement may comprise first sensors for detecting the steering parameter and at least one second sensor for detecting a position of the locking element in a structural unit (13).”

The present invention relates to a steering column having the features of the precharacterizing clause of claim 1.

Steering columns for motor vehicles are known in many different designs. Steering columns in which a steering shaft is rotatably mounted in a steering column jacket are generally used. The steering column jacket itself is axially adjustably mounted in a boxed swing arm. To enable a vertical adjustment of the steering wheel, the boxed swing arm is in turn pivotably mounted on a console to be fastened to the vehicle. Steering columns are furthermore known in which a further electric power assist system, which acts directly on the steering shaft, is provided on the steering column.

Virtually all steering columns moreover comprise a locking device, the so-called steering lock, which is intended to secure the parked vehicle against unauthorized use. Such locking devices are actuated purely mechanically via a key or electrically by an actuator.

Steering columns having an electrically actuated steering lock are known from the prior art. In this regard, for example, DE 199 27 542 B4 discloses a steering column switch module having a steering angle sensor and a steering column lock. In this case, the steering column switch module is fastened to the steering column via the steering column lock. Particular technical features of the steering column lock are not revealed in this document.

The closest prior art is known from DE 10 2004 026 868 B4. This patent discloses a steering angle sensor provided with a spur gear for precise measurement of the steering angle, i.e. the angle of rotation of the steering column. By means of a gear reduction, the spur gear enables detection of the absolute steering angle over a wide rotational range of the steering wheel through multiple full revolutions. An electrical steering lock is furthermore disclosed, which arrests the steering shaft by means of a blocking bolt. The steering lock is electrically actuated. An electric motor is provided as the actuator. The steering angle sensor and the steering shaft lock are combined in a module for assembly purposes. In this case, the steering angle sensor and the steering shaft lock are arranged opposite one another relative to the steering shaft, which passes centrally through the module.

Starting from this prior art, the object of the present invention is to propose a compact design for a steering column having an electrical steering lock in which, in particular, a reduction in the number of components is achieved.

This object is achieved by a steering column having the features of claim 1.

Since, in a steering column provided for a motor vehicle, having a steering shaft which is rotatably mounted in a boxed swing arm, having a latching element connected to the steering shaft in a torsion-resistant manner and having a locking element which may be brought into engagement with the latching element for temporary blocking of the steering shaft, and having a sensor arrangement, which is designed to detect a steering parameter, namely the angle of rotation of the steering shaft or the torque acting on the steering shaft, and having an electromechanical actuator for actuating the locking element depending on a control, the feature is additionally provided that the sensor arrangement comprises first sensors for the steering parameter and at least one second sensor for detecting the position of the locking element in a structural unit, the sensors for the steering parameter and for the position of the locking element can be assembled and/or contacted together so that a more compact design is produced with reduced assembly costs.

In this case, the locking element can preferably be a latching bolt and the latching element can be a latching star fastened to the steering shaft in a torsion-resistant manner.

In the case of electromechanical power-assisted steering systems, it is particularly advantageous if the first sensors are Hall sensors of a torque sensor since a torque sensor can be mounted in the spatial vicinity of the locking element and the control of the power-assisted steering system can read out and control these two electrical components together.

In this case, a particularly compact and economically manufactured construction can be achieved if the structural unit, which comprises the first sensors and the at least one second sensor, is a common printed circuit board on which the first sensors and the at least one second sensor are arranged.

In a motor vehicle steering system which is equipped or combined with the steering column according to the invention, an electromotive servo drive is preferably provided, which is arranged on the steering column or on a steering gear operatively connected to the steering column and which comprises a control which is designed to detect signals of the sensor arrangement as input signals and to control the actuator. It is therefore possible to structurally integrate the control in the servo drive. In this case, it is advantageous if the sensor arrangement and the actuator are connected to the control of the servo drive via a common electrical line, i.e. the sensor and locking assembly is connected to the control via a single electrical connection. In this case, the connection will expediently be multi-polar or multi-core, but the number of plug connections is minimized, which reduces costs and the assembly effort and also the number of possible error sources.

The electrical power supply of the actuator can moreover take place via the common electrical line.

A simple compact construction is possible if the locking element is pivotably mounted on, or displaceably mounted in, the boxed swing arm. The forces which act mechanically on the locking element, in particular in the event of misuse, are then introduced directly into the boxed swing arm so that the actuator itself can be designed to be smaller and lighter than if the actuator has to absorb the said forces.

In this case, the locking element is preferably supported in a guide, in particular in a linear guide in the boxed swing arm.

Other advantageous features which can illustrate preferred embodiments of the invention individually or in combination with one another are also revealed in the description of the figures. Preferred embodiments are explained in more detail below with reference to the drawings, which show:

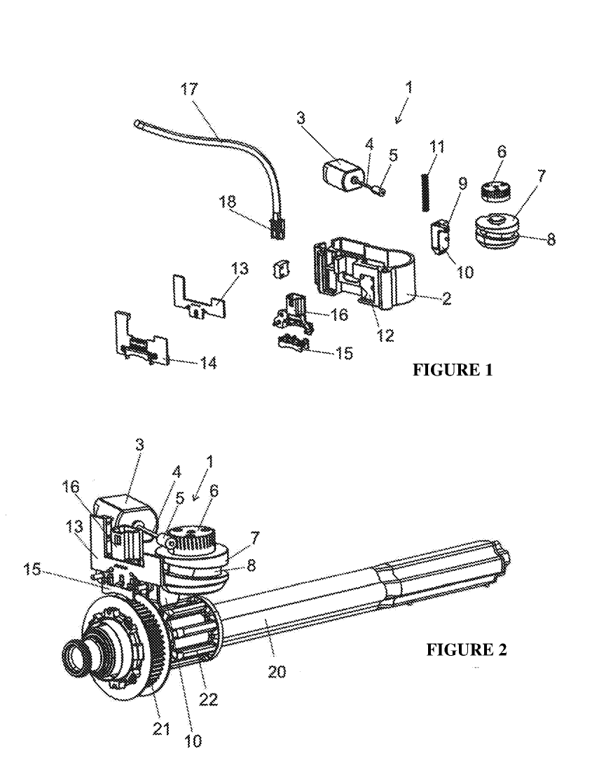

FIG. 1: an electromechanical locking unit for a steering column according to the invention in an exploded illustration;

FIG. 2: the locking unit of FIG. 1, without a housing, in the assembled position on a part of a steering shaft;

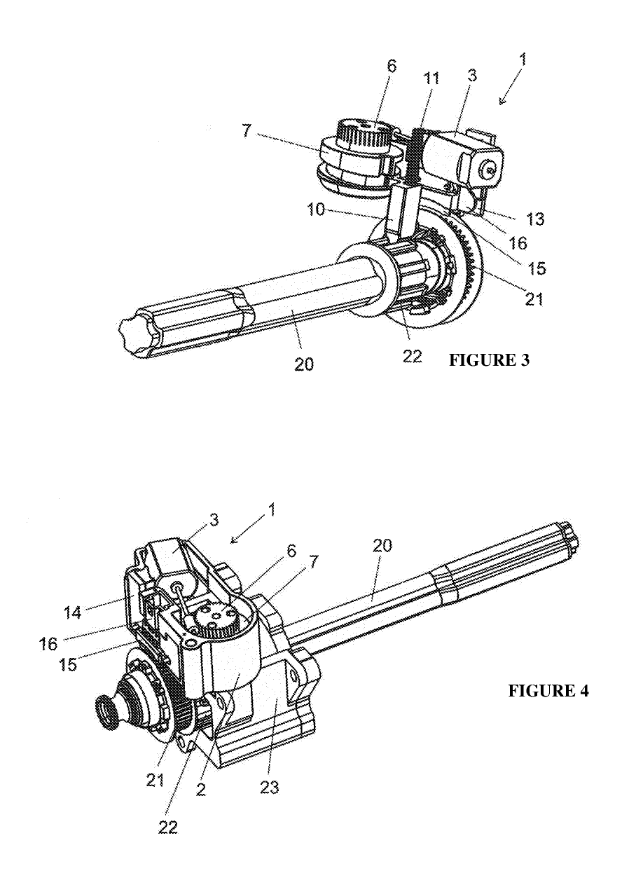

FIG. 3: the arrangement of FIG. 2 in another view;

FIG. 4: the arrangement of FIG. 2 with further housing elements;

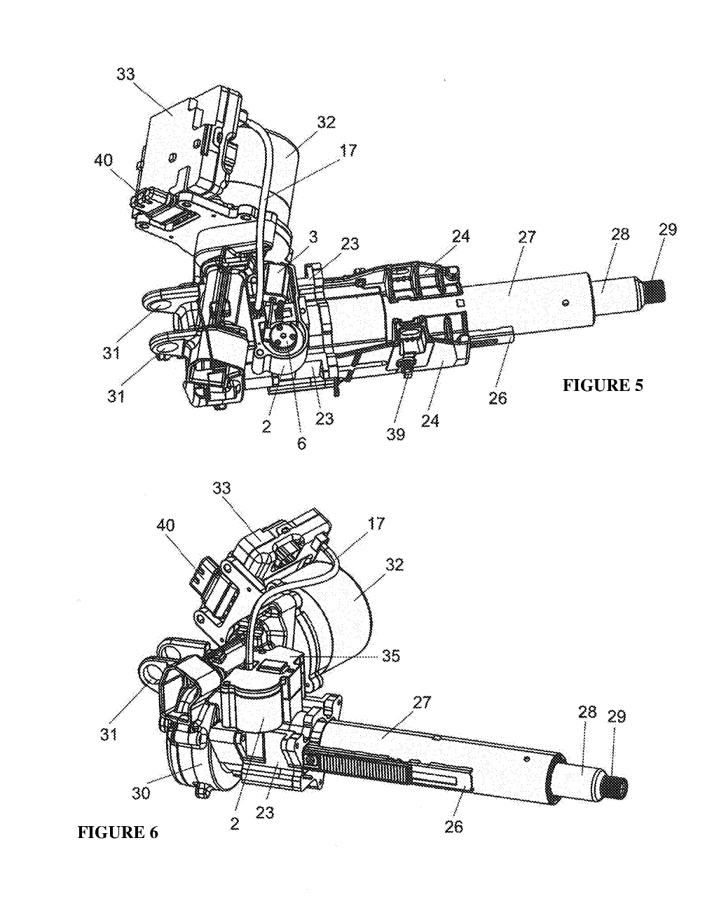

FIG. 5: the arrangement of FIG. 4 with an assembled boxed swing arm and an electric servo drive which acts on the steering shaft;

FIG. 6: the arrangement of FIG. 5 in another illustration; and

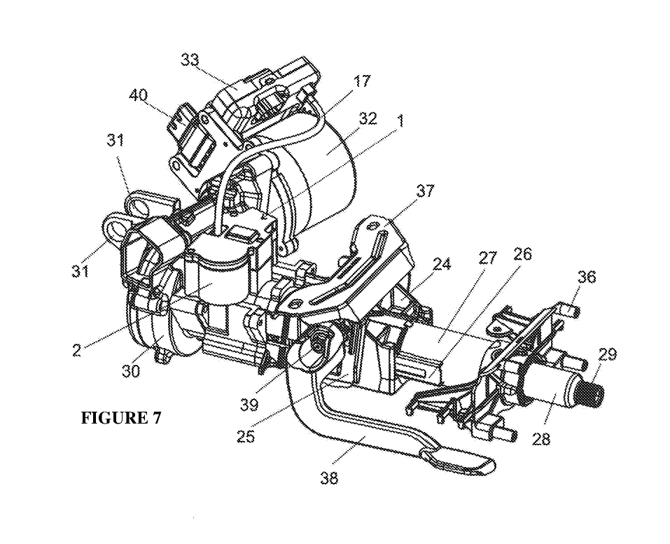

FIG. 7: a fully assembled steering column with an adjusting device and console for assembly in a motor vehicle.

FIG. 1 shows, in an exploded illustration, an electromechanical locking unit 1 for a steering column of a motor vehicle. The locking unit 1 comprises a housing 2, in which an electric motor 3 having a motor shaft 4 and a driven worm gear 5 is assembled. In the assembled state, the worm gear 5 meshes with a gearwheel 6 which is connected to a sliding gate gear 7 in a torsion-resistant manner. The sliding gate gear 7 has a circumferential sliding gate 8 in which a driver 9 of a latching bolt 10 engages in the assembled state. The latching bolt 10 is pretensioned in the downwardly pointing direction in FIG. 1 by means of a helical spring 11. The gear wheel 6 and the sliding gate gear 7 are rotatably mounted in the housing 2.

The housing 2 furthermore incorporates an assembly region 12 for a printed circuit board 13 and a cover plate 14. A flux collector 15 and an electrical contact 16 are moreover arranged in the assembly region 12. The electrical contact 16 is designed as a plug connection and serves for connecting an electrical line 17 by means of a multi-pole plug 18, wherein the electrical line 17 is not part of the assembly of the electromechanical locking unit 1.

The assembled state of the electromagnetic locking unit 1 on a steering shaft 20 is shown in FIG. 2, wherein the housing 2 has been omitted for improved clarity. Similar or functionally similar structural elements are denoted by the same reference signs here, which is also the case in the further description of the figures. For improved clarity, it is possible that some reference numerals are not repeatedly mentioned.

FIG. 2 therefore shows the locking unit 1 having the electric motor 3 which drives the gearwheel 6 via the motor shaft 4 and the worm gear 5. The gearwheel 6 in turn drives the sliding gate gear 7 in the sliding gate 8 of which the pin 9 (not visible here) of the latching bolt 10 engages. The sliding gate gear 7 is arranged in the direct vicinity of the printed circuit board 13. The printed circuit board 13 is in turn assembled together with the flux collector 15 directly adjacent to a rotation angle transmitter 21 so that the rotation angle transmitter 21, whereof the magnetic field is conducted and concentrated via the flux collector 15, transmits a magnetic field to first sensors on the printed circuit board 13. The first sensors are suitable and designed for detecting and evaluating the angular position of the rotation angle transmitter 12 and the associated steering shaft 20. Depending on the design, this can be provided as a steering angle sensor or as a steering torque sensor. In the embodiment illustrated here, it is a torque sensor.

The printed circuit board 13 furthermore incorporates a second sensor (not visible here), which identifies the position of the sliding gate gear 7. Only the end position of the sliding gate gear 7, i.e. the end position in both directions of rotation, is identified. As a result of the mechanical forced coupling of the sliding gate gear 7 with the latching bolt 10, the position of the latching bolt 10 may therefore also be detected in the end positions.

The steering shaft 20 furthermore incorporates a latching star 22 in which the latching bolt 10 can engage in a known manner in order to arrest the steering shaft and therefore prohibit a steering procedure to prevent unauthorized use of the motor vehicle, even by pushing or towing. To this end, a current can be supplied to the electric motor 3. In a first direction of rotation of the electric motor 3, the latching bolt 10 can be moved into the latching star 22 so that the steering shaft 20 is blocked. When a current is supplied in the opposite direction, the electric motor 3 moves the latching bolt 10 out of the latching star 22 and thus releases the steering shaft 20. Identifying the end positions by means of the sensor enables the evaluation of the signal for control purposes on the one hand and the shut-off of the electric motor 3 when the respective target end position is reached on the other, which means that the current supply to the electric motor 3 does not have to be unnecessarily long, but, at the same time, the end position is reliably reached and this can also be verified.

FIG. 3 shows the arrangement of FIG. 2 in another view. It can be seen that the latching bolt 10, which is illustrated in its engaged position in the latching star 22 here, reaches through the housing 2 (not illustrated) towards the latching star. In light of the considerable forces which act on a steering shaft lock in the event of misuse, this means that the latching bolt 10 cannot be fully mounted in the locking unit 1. This is explained in more detail below.

FIG. 4 shows the steering column of FIGS. 2 and 3 in a perspective illustration with further components. In contrast to the illustration of FIGS. 2 and 3, the housing 2 of the locking unit 1 is illustrated here. The housing incorporates and supports the electric motor 3 and the other components illustrated in FIG. 1. The housing 2 itself is arranged on a housing part 23, which is part of the steering column and can comprise a bearing of the steering shaft 20, in such a way that the steering shaft 20 is rotatably mounted in the housing part 23. In particular, the housing part 23 also surrounds the latching star 22 circumferentially and supports the latching bolt 10 (not visible in this illustration) in such a way that the latching bolt 10 is displaceable in the substantially radial direction towards the latching star 22 but the transverse forces involved, which are exerted by the latching star during a manual rotational movement of the steering column 20, can be absorbed by the housing part 23 without any of the components becoming damaged. It is also clear here that the housing 2, with its thin-walled and correspondingly light design, is not adequately dimensioned for absorbing such forces in the event of misuse.

FIG. 5 shows a further assembly step of the steering column of FIG. 4. The assembly of FIG. 4 is supplemented here by further components. In this regard, a second housing part 24, which comprises an adjusting device 25, known per se, for vertical adjustment of the steering column and an adjusting device 26, likewise known, for axial adjustment of the steering column, are assembled in particular directly on the housing part 23. The second housing part 24 also incorporates an outer steering column jacket 27 in which a part 28 of the overall steering shaft is rotatably mounted, which part is on the steering-wheel side. The part 28 on the steering-wheel side comprises a gearing 29 for assembling a steering wheel. The steering shaft 20 in FIG. 4 comprises a non-circular, in particular an approximately cloverleaf-shaped, outer profile. The steering shaft part 28 comprises a correspondingly compatible inner profile so that the two steering shaft parts 20 and 28 can engage in one another and form a torsion-resistant but telescopic arrangement. A further housing part 30 is arranged at the opposite end of the steering column, which further housing part, on the one hand, incorporates bearing points 31 for the pivotable bearing of the steering column on a console 37 in a motor vehicle and, on the other, incorporates a bearing for a drive shaft of a servo drive 32. The drive shaft, its bearing and the gear for coupling the servo drive to the steering shaft 20 are known from the prior art and are not illustrated in more detail here.

The housing parts 23, 24 and 30, together with other smaller components, form the so-called boxed swing arm which, on the one hand, as an essentially supporting component of the steering column, receives the bearing of the steering shaft 20 and, on the other, enables the above-mentioned adjustment options in the vertical direction (as seen with reference to the driver) and in the axial direction of the steering column. The term “boxed swing arm” comes from the box-shaped construction and the end-side bearing in the bearing points 31, which pivotably supports this assembly on a console 37 in the manner of a swing arm.

The servo drive 32 conventionally has a brushless electric motor, which is controlled by a control 33. In this exemplary embodiment, the control 33 is connected to the locking unit 1 via the line 17, which has already been described above with reference to FIG. 1. The first sensors of the torque sensor and the second sensors for identifying the end positions of the steering lock are interrogated via the line 17. The supply voltage for the electric motor 3 of the locking unit 1 is moreover conducted via the cable 17. Multiple advantages which can be used constructively are created by this construction. On the one hand, only one electrical connection is required between the locking unit 1 and the control 33, which minimizes costs and assembly time. On the other, the data of the torque sensor and the lock (end position sensor) are provided via the same cable or plug connection in the control 33. The construction of the locking unit 1 can be realized using light materials since the substantial forces which occur in the event of misuse are introduced by the latching bolt 10 not into the housing 2 of the locking unit 1, but into the housing part 23 of the boxed swing arm. Therefore, the locking unit 1 can be designed to be relatively light and small. The electric motor 3 can therefore likewise be kept small and be driven with low power. This feature is also advantageous since the electrical connection 17 only has to transmit correspondingly low currents and therefore only small line cross-sections are required.

FIG. 6 shows a further assembly step of the steering column according to the invention. In this assembly step, the housing 2 is closed at its upper side by a cover 35. The housing part 24 is not present in this illustration.

The complete assembly of the steering column is illustrated in FIG. 7. In contrast to the illustration of FIG. 6, the steering column is further completed by an assembly base 36 for the steering column switch of the vehicle, having a console 37 for fastening the steering column to the chassis of a vehicle and having a clamping lever 38, which optionally releases or locks both the vertical adjustment 25 and the axial adjustment 26 via a clamping bolt 25. In the steering column, as illustrated in FIG. 7, all components for the electric power assist system (motor 32 and control 33), as well as the electromechanical locking unit 1, are already assembled. The torque sensor required for controlling the servo drive is realized in the manner described above. The contacting of the torque sensor and the electromechanical locking unit 1 is realized via a single cable 17, which is already definitively mounted on the steering column and connects the control 32 to the locking unit 1 and to the associated torque sensor. This connection can therefore already be produced and tested during the assembly of the steering column, before being fitted on the motor vehicle. For final contacting after the assembly of the steering column in the motor vehicle, only a single plug connection 40 is provided on the control 33.

The steering column thus described therefore has a compact construction, is light and can be assembled in a motor vehicle with little effort. The functioning is particularly reliable since the entire assembly, in particular of the sensor for the steering parameter (here: torque), and the electromechanical lock can already be assembled and tested by the steering-column manufacturer.

The said advantages are also substantially apparent if, unlike in the illustrated exemplary embodiment, the servo drive is not arranged on the steering column but on the steering gear, in the region of the front axis. Advantages are also revealed in this case as a result of the common assembly of the sensors on a common printed circuit board and the common contacting of the sensors and the electromechanical lock via a single electrical connection.

1.-8. (canceled)

9. A steering column for a motor vehicle comprising:
a steering shaft that is rotatably mounted in a boxed swing arm;
a latching element connected to the steering shaft in a torsion-resistant manner;
a locking element that is configured to engage with the latching element to block the steering shaft;
a sensor arrangement that comprises first sensors for detecting a steering parameter and a second sensor for detecting a position of the locking element in a structural unit; and
an electromechanical actuator that actuates the locking element depending on a control.

10. The steering column of claim 9 wherein the steering parameter is an angle of rotation of the steering shaft or a torque acting on the steering shaft.

11. The steering column of claim 10 wherein the first sensors are Hall sensors of a torque sensor.

12. The steering column of claim 10 wherein the structural unit is a printed circuit board on which the first sensors and the second sensor are disposed.

13. The steering column of claim 10 comprising an electromotive servo drive that includes the control, which detects signals of the sensor arrangement as input signals and controls the electromechanical actuator.

14. The steering column of claim 13 wherein the sensor arrangement and the electromechanical actuator are connected to the control of the electromotive servo drive via an electrical line.

15. The steering column of claim 10 wherein an electrical power supply of the electromechanical actuator is realized via an electrical line.

16. The steering column of claim 10 wherein the locking element is pivotably or displaceably mounted in the boxed swing arm.

17. The steering column of claim 10 wherein the locking element is supported in a guide in the boxed swing arm.
